(19) United States
(12) Patent Application Publication
(10) Pub. No.: US 2023/0033527 A1
(43) Pub. Date: Feb. 2, 2023

(54) IMAGE FORMING APPARATUS, IMAGE FORMING METHOD, AND IMAGE FORMING SYSTEM CAPABLE OF RELIABLE REMOTE OUTPUT

(71) Applicant: KYOCERA Document Solutions Inc., Osaka (JP)

(72) Inventors: Norifumi MIYAHARA, Torrance, CA (US); Yoshihiro OSADA, Torrance, CA (US); Keizen KANAZAWA, Osaka (JP); Kunihiko SHIMAMOTO, Torrance, CA (US)

(73) Assignee: KYOCERA Document Solutions Inc., Osaka (JP)

(21) Appl. No.: 17/386,395

(22) Filed: Jul. 27, 2021

(51) Int. Cl. G06F 3/12

(52) U.S. Cl. CPC G06F 3/1207; G06F 3/1259; G06F 3/1284

(57) ABSTRACT

Provided is an image forming apparatus capable of reliably outputting remotely. The job acquisition unit acquires a job. When the job is acquired by the job acquisition unit, an imaging unit captures the surroundings and acquires image data. The person detection unit detects a person in the image data imaged by the imaging unit. When the person is detected by the person detection unit, the notification unit notifies the person to request a response to the job. The image forming unit forms an image of the job after the notification by the notification unit.

### BACKGROUND

The present disclosure relates to an image forming apparatus, an image forming method, and an image forming system, and more particularly to an image forming apparatus, an image forming method, and an image forming system that output from a remote terminal.

There is an image forming apparatus such as multifunctional peripheral (MFP), or the like, that can print documents and images from a terminal such as PCs (Personal Computers), smartphones, or the like, via a network, and an image forming system including these.

There is a typical image forming system that a print job transmission unit for transmitting a print job to a target device is provided in the terminal, and each MFP detects a user's terminal existing within a predetermined distance from its own device by GPS and Bluetooth (registered trademark). In this image forming system, a download request is sent to a print server, a print job is received, and when the user is authenticated, a print job having the user identification information of the authenticated user is extracted, and an image is formed.

### SUMMARY

An image forming apparatus according to the present disclosure includes a job acquisition unit configured to acquire a job; an imaging unit configured to acquire an image data by imaging the surroundings when the job is acquired by the job acquisition unit; a person detection unit configured to detect a person in the image data acquired by the imaging unit; a notification unit configured to notify the person to request a response to the job when the person is detected by the person detection unit; and an image forming unit configured to form an image of the job after being notified by the notification unit.

An image forming method according to the present disclosure is an image forming method performed by an image forming apparatus includes the steps of : acquiring a job; acquiring an image data by imaging the surroundings when the job is acquired; detecting a person in acquired image data; notifying the person to request a response to the job when the person is detected; and forming an image of the job after being notified.

An image forming system according to the present disclosure is an image forming system having a terminal, an image forming apparatus, and a server, including: a job acquisition unit configured to acquire a job; an imaging unit configured to acquire an image data by imaging the surroundings when the job is acquired by the job acquisition unit; a person detection unit configured to detect a person in the image data acquired by the imaging unit; a notification unit configured to notify the person to request a response to the job when the person is detected by the person detection unit; and an image forming unit configured to form an image of the job after being notified by the notification unit.

### BRIEF DESCRIPTION OF THE DRAWINGS

FIG. 1 is a block diagram showing a control configuration of an image forming apparatus according to an embodiment of the present disclosure;

FIG. 2 is a diagram showing a schematic configuration of the image forming apparatus as shown in FIG. 1;

FIG. 3 is a block diagram showing a functional configuration of the image forming apparatus as shown in FIG. 2;

FIG. 4 is a flowchart of the remote output process according to the embodiment of the present disclosure;

FIG. 5 is a conceptual diagram of the detection range limitation in the remote output process shown in FIG. 4; and

FIG. 6 is a block diagram showing a functional configuration of an image forming apparatus system according to another embodiment of the present disclosure.

### DETAILED DESCRIPTION

### Embodiment

[Control Configuration of Image Forming Apparatus 1]

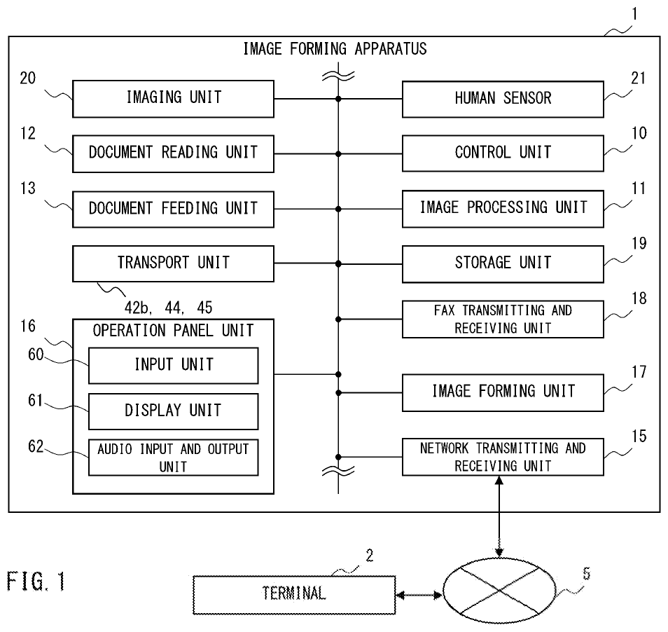

Firstly, with reference to FIG. 1, a control configuration of the image forming apparatus 1 is described.

The image forming apparatus 1 includes a control unit 10, an image processing unit 11, a document reading unit 12, a document feeding unit 13, a network transmitting and receiving unit 15, an operation panel unit 16, the image forming unit 17, FAX transmitting and receiving unit 18, a storage unit 19, the imaging unit 20, the human sensor 21, and the like. Each unit is connected to the control unit 10, and its operation is controlled by the control unit 10.

The control unit 10 is an information processing part, such as GPP (General Purpose Processor), CPU (Central Processing Unit), MPU (Micro Processing Unit), DSP (Digital Signal Processor), GPU (Graphics Processing Unit), ASIC (Application Specific Integrated Circuit, a processor for specific applications), or the like.

The control unit 10 reads the control program stored in the ROM or HDD of the storage unit 19, expands the control program in the RAM, and executes the control program, so that the control unit 10 can be operated as each part of the functional block as described later. Further, the control unit 10 controls the entire apparatus according to specified instruction information input from the terminal 2 or the operation panel unit 16.

The image processing unit 11 is a control calculation means such as a DSP, a GPU, an ASIC, or the like. The image processing unit 11 performs specific image processing on various image data. The specific image processing may be, for example, processing such as enlargement/reduction, density adjustment, gradation adjustment, image improvement, or the like.

Further, the image processing unit 11 stores the image data read by the document reading unit 12 in the storage unit 19 as print data. At this time, the image processing unit 11 can also convert the print data into an electronic document such as PDF, or the like, or a file such as TIFF file, or the like. Further, the image processing unit 11 may be able to execute at least a part of OCR (Optical Character Recognition) processing.

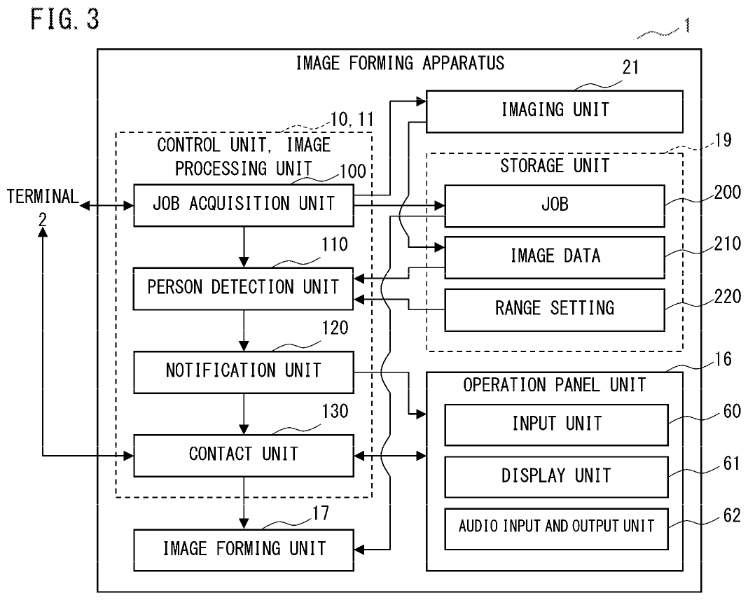

Further, the image processing unit 11 may include, for example, an accelerator of a convolutional neural network (hereinafter, referred to as “CNN”). Thus, the image processing unit 11 may be able to recognize a person or an object from the image data 210 (FIG. 3) acquired by the imaging unit 20.

The document reading unit 12 is a scanning unit that reads a document placed on the document feeding unit 13.

The document feeding unit 13 is an auto sheet feeder unit, or the like, on which a document is placed and the document is conveyed to the document reading unit 12.

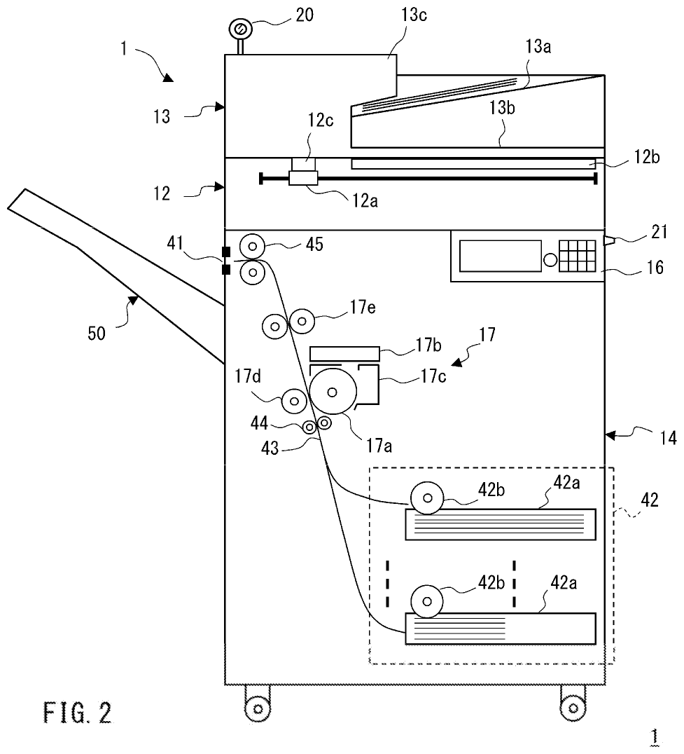

The paper feed roller 42b (FIG. 2), the transport roller pair 44, and the discharge roller pair 45, which are described later, serve as a transport unit for transporting the recording paper.

Network transmitting and receiving unit 15 is a network connection unit including a LAN (Local Area Network) board, a wireless transceiver, or the like, for connecting to the network 5.

The network 5 of the present embodiment is, for example, a LAN, a wireless LAN (Wi-Fi), a WAN (Wide Area Network), a mobile phone network, a voice telephone network, or the like.

In the present embodiment, the terminal 2 owned by a user is connected by the network 5. The terminal 2 is a PC (Personal Computer), a smartphone, a tablet, a dedicated terminal, or the like.

The network transmitting and receiving unit 15 transmits/receives data on a data communication line, and it transmits/receives a voice signal on a voice telephone line.

The operation panel unit 16 is an operation interface unit in which the user gives various instructions to the image forming apparatus 1. Further, the operation panel unit 16 is arranged on the front side of the main body unit 14.

The operation panel unit 16 includes input unit 60, display unit 61, and audio input and output unit 62.

The input unit 60 includes buttons, a touch panel, and the like. The buttons of the input unit 60 of the operation panel unit 16 are a numeric keypad, a button for starting, canceling, switching an operation mode, and instructing a job 200. Of these, the operation mode may include modes such as copying, fax transmission, scanner, network scanner, or the like. Further, instructions to job 200 includes instructions for printing, sending, saving, recording, or the like, for the selected document.

The input unit 60 of the operation panel unit 16 acquires various instructions for jobs 200 of the image forming apparatus 1 by the user. It is also possible to input and change the information of each user according to the user's instruction acquired from the operation panel unit 16.

The display unit 61 includes an LCD (Liquid Crystal Display), an organic EL (Organic Electro Luminescence) display, an LED (Light Emitting Diode), and the like.

The audio input and output unit 62 includes a microphone, A/D (Analog-to-Digital) converter, D/A (Digital-to-Analog) converter, a speaker, an amplifier, or the like. The audio input and output unit 62 can be used to make a voice communication between the person in front of the image forming apparatus 1 and the user of the terminal 2.

The image forming unit 17 forms an image from the print data, which is stored in the storage unit 19, read by the document reading unit 12, or acquired from the terminal 2, or the like, on the recording paper according to the output instruction of the user.

The FAX transmitting and receiving unit 18 transmits/receives a facsimile. The FAX transmitting and receiving unit 18 can receive a facsimile from another FAX apparatus via a voice line, store the facsimile image data in the storage unit 19, and cause the image forming unit 17 to form an image. Further, the FAX transmitting and receiving unit 18 can convert the document, which is read by the document reading unit 12, or the network FAX data, which is transmitted from the terminal 2, into image data 210, and it can perform facsimile transmission to another FAX apparatus by voice line.

The storage unit 19 is a non-transitory recording medium such as a semiconductor memory of a ROM (Read Only Memory), a RAM (Random Access Memory), or the like, and an HDD (Hard Disk Drive), or the like.

The RAM of the storage unit 19 retains the stored contents by a function such as self-refresh, or the like, even in a power saving state.

A control program for controlling the operation of the image forming apparatus 1 is stored in the ROM or HDD of the storage unit 19. In addition to this, the storage unit 19 also stores the user's account settings. Further, the storage unit 19 may include an area of a storage folder for each user.

The imaging unit 20 is a camera including an image sensor such as a CMOS (Complementary Metal Oxide Semiconductor) image sensor, a CCD (Charge Coupled Device) image sensor, or the like, with an optical element such as a lens, an image encoding circuit, and the like.

The imaging unit 20 can image the surroundings of the image forming apparatus 1 in the front direction with an angle of view in a specific range according to an instruction from the control unit 10. The imaging unit 20 stores the captured image data 210 (FIG. 3) in the storage unit 19 of the main body unit 14.

The human sensor 21 is an infrared sensor, or the like, which detects a heat source of a person. The human sensor 21 may be, for example, capable of detecting the heat source even in a power saving state.

[Appearance and Internal Schematic Configuration of Image Forming Apparatus 1]

Next, with reference to FIG. 2, the external appearance and the internal schematic configuration of the image forming apparatus 1 according to the present embodiment is described.

The document reading unit 12 is arranged on the upper part of the main body unit 14, and the document feeding unit 13 is arranged on the upper part of the document reading unit 12. The stack tray 50 is arranged on the discharge port 41 side of the recording paper formed in the main body unit 14. Further, the operation panel unit 16 is arranged on the front side of the image forming apparatus 1.

The document reading unit 12 includes a scanner 12a, a platen glass 12b, and a document reading slit 12c. The scanner 12a is configured with an exposure lamp, a CMOS image sensor or a CCD image sensor, and the like. The scanner 12a can be moved in the direction in which the document is conveyed by the document feeding unit 13. The platen glass 12b is a platen made of a transparent member such as glass. The document reading slit 12c has a slit formed in a direction orthogonal to the document transport direction by the document feeding unit 13.

When reading a document placed on the platen glass 12b, the scanner 12a is moved to a position facing the platen glass 12b. At this time, the scanner 12a scans and reads the document placed on the platen glass 12b to acquire the image data 210. The scanner 12a stores the acquired image data 210 in the storage unit 19 in the main body unit 14.

Further, when reading the document conveyed by the document feeding unit 13, the scanner 12a is moved to a position facing the document reading slit 12c. At this time, the scanner 12a reads the document and acquires the image data 210 via the document reading slit 12c in synchronization with the document transport operation by the document feeding unit 13. The scanner 12a stores the acquired image data 210 in the storage unit 19.

The document feeding unit 13 includes a document placing unit 13a, a document ejection unit 13b, and a document transport mechanism 13c. The documents placed on the document placing unit 13a are sequentially fed out one by one by the document transport mechanism 13c and transported to a position facing the document reading slit 12c, and then ejected to the document ejection unit 13b.

The document feeding unit 13 is configured to be foldable, and the upper surface of the platen glass 12b can be opened by lifting the document feeding unit 13 upward.

The main body unit 14 includes an image forming unit 17, a paper feeding unit 42, a paper transport path 43, a transport roller pair 44, and a discharge roller pair 45.

The paper feed unit 42 includes a plurality of paper feed cassettes 42a and a paper feed roller 42b. Each of the plurality of paper cassettes 42a stores recording papers having different sizes or orientations. The paper feed roller 42b feeds the recording paper one by one from a paper feed cassette 42a to the paper transport path 43.

As described above, the paper feed roller 42b, the transport roller pair 44, and the discharge roller pair 45 function as a transport unit. The recording paper is conveyed by the conveying unit.

The recording paper fed out to the paper transport path 43 by the paper feed roller 42b is conveyed to the image forming unit 17 by the transport roller pair 44. Then, the recording paper recorded by the image forming unit 17 is discharged to the stack tray 50 by the discharge roller pair 45. The stack tray 50 includes a sensor that detects whether or not the recording paper is discharged.

The image forming unit 17 includes a photoconductor drum 17a, an exposure unit 17b, a developing unit 17c, a transfer unit 17d, and a fixing unit 17e. The exposure unit 17b is an optical unit including a laser device, a mirror, a lens, an LED array, and the like. The exposure unit 17b outputs light, or the like, to the photoconductor drum 17a primarily charged by the charging unit to expose the photoconductor drum 17a by outputting light or the like based on the image data 210, and it forms an electrostatic latent image on the surface of the photoconductor drum 17a. The developing unit 17c develops an electrostatic latent image formed on the photoconductor drum 17a by using toner, and the developing unit 17c forms a toner image based on the electrostatic latent image on the photoconductor drum 17a. The transfer unit 17d transfers the toner image formed on the photoconductor drum 17a by the developing unit 17c to the recording paper. The fixing unit 17e heats the recording paper on which the toner image is transferred by the transfer unit 17d to fix the toner image on the recording paper.

In the present embodiment, the imaging unit 20 is provided, for example, on the upper part of the document reading unit 12.

In the present embodiment, the human sensor 21 is provided on, for example, the operation panel unit 16.

In addition, in the image forming apparatus 1, the control unit 10 and the image processing unit 11 may be integrally formed such as a GPU built-in CPU, a chip-on module package, an SOC (System On a Chip), or the like.

Further, the control unit 10 and the image processing unit 11 may have a built-in RAM, ROM, flash memory, or the like.

[Functional Configuration of Image Forming Apparatus 1]

Here, with reference to FIG. 3, the functional configuration of the image forming apparatus 1 is described.

The control unit 10 and the image processing unit 11 of the image forming apparatus 1 include a job acquisition unit 100, a person detection unit 110, a notification unit 120, and a contact unit 130.

The storage unit 19 stores the image data 210 and the range setting 220.

The job acquisition unit 100 acquires the job 200 from the terminal 2 via the network 5.

The person detection unit 110 detects a person in the image data 210 imaged by the imaging unit 20. This person detection may be performed by using, for example, a trained CNN.

In addition, the person detection unit 110 may detect a person only within the range for detecting a person (hereinafter, referred to as “detection range”) set in the range setting 220.

The person detected by the person detection unit 110 does not have to be a user registered in the image forming apparatus 1.

The notification unit 120 notifies a person when the person is detected by the person detection unit 110. This notification is for requesting the person to respond to the job 200.

In the present embodiment, the notification by the notification unit 120 includes one of or any combination of blinking the LED light on the display unit 61, a notification sound or call by voice from the audio input and output unit 62, and e-mail transmission.

The contact unit 130 contacts the person notified by the notification unit 120 with the user of the terminal 2. This contact can be performed by using the audio input and output unit 62 and the display unit 61 of the operation panel unit. The contact unit 130 can also send and receive text messages to and from the terminal 2.

In the present embodiment, the imaging unit 20, when the job 200 is acquired by the job acquisition unit 100, images the surroundings and acquires the image data 210.

Further, in the present embodiment, the imaging unit 20 may image the image data 210 even when the recording paper, or the like on which the job 200 is printed (hereinafter referred to as “printed matter”) is taken out. Specifically, in the present embodiment, when the “forced output mode” as described later is set for the job 200, the person who took out the printed matter is imaged.

Image data 210 is data of image, which is imaged by the imaging unit 20. The image data 210 may be still image data or movie image data. The image data 210 may be compressed by various codecs.

The range setting 220 is setting data of a detection range within the imaging range by the imaging unit 20. This range is specified by the angle of view of the imaging unit 20, the rectangular coordinates of the image data 210, and the like, and a detection range or a range not detected by a person may be set. The imaging range setting 220 can be arbitrarily set by the administrator or the user by using the terminal 2 or the operation panel unit 16. In the present embodiment, as described later, for example, the range setting 220 is set when the job 200 is generated. Further, the imaging range setting 220 may be added to the job 200 as metadata.

In the present embodiment, the image forming unit 17 forms the image of the job 200 after the notification by the notification unit 120.

Here, the control unit 10 and the image processing unit 11 of the image forming apparatus 1 execute the control program stored in the storage unit 19 to execute the control program, and is function as the job acquisition unit 100, the person detection unit 110, the notification unit 120, and the contact unit 130.

Further, each part of the image forming apparatus 1 as described above becomes a hardware resource for executing the image forming method of the present disclosure.

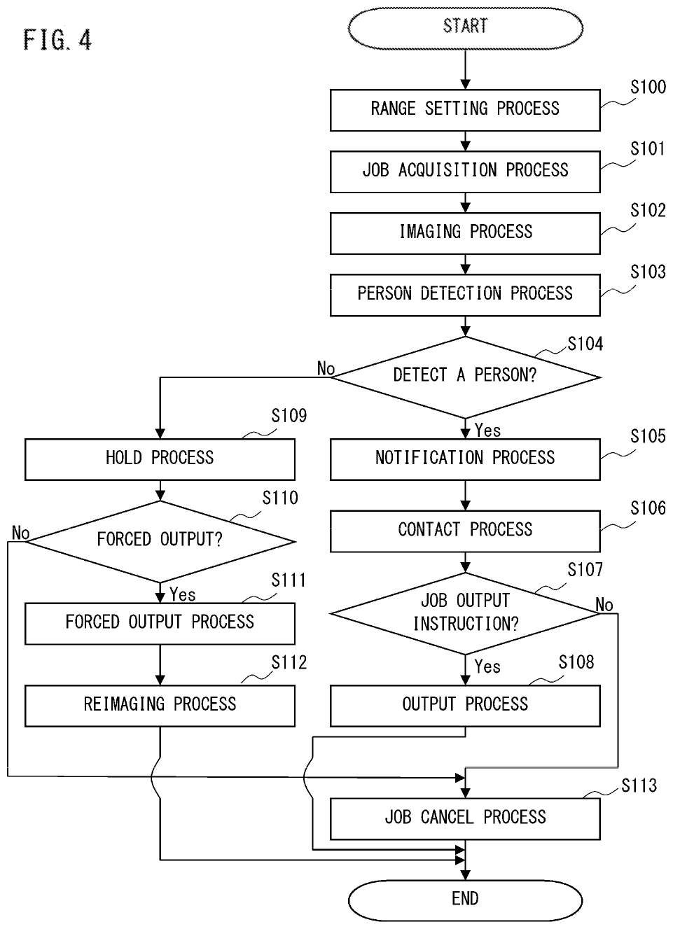

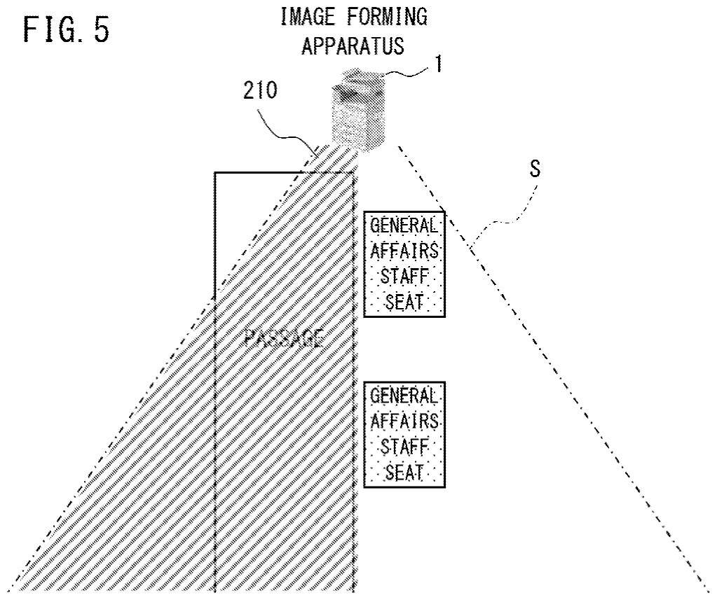

In addition, apart or any combination of the above-mentioned functional configurations may be configured in hardware or circuit by IC, programmable logic, FPGA (Field-Programmable Gate Array), or the like.

[Remote Output Process by Image Forming Apparatus 1]
Next, with reference to FIGS. 4 to 5, the remote output process by the image forming apparatus 1 according to the embodiment of the present disclosure is described.

In remote output process according to the present embodiment, firstly, the job 200 is acquired from the terminal 2 in a remote environment such as the user's home (hereinafter, simply referred to as “remote”). If the job 200 is acquired, the surroundings are imaged and the image data 210 is acquired. Then, the person detection is performed in the image data 210. If a person is detected, a notification is performed to the person for requesting to respond to the job 200. After this notification, the image of job 200 is formed.

In the remote output process of the present embodiment, the control unit 10 and the image processing unit 11 mainly execute the program stored in the storage unit 19 in cooperation with each unit and use the hardware resources.

Hereinafter, with reference to the flowchart of FIG. 4, the details of the remote output process according to the present embodiment is described step by step.

(Step S100)

At first, the person detection unit 110 performs the range setting process.

Here, according to the instruction of the user who wants to output the job 200, the terminal 2 in remote executes various application software, and the like (hereinafter, simply referred to as “application”).

On this basis, the user of the terminal 2 gives a print instruction on the application. Then, the device driver program for the image forming apparatus 1 and/or the dedicated application for job transmission (hereinafter, referred to as “driver, or the like”) are started. As a result, the user specifies the image forming apparatus 1 and instructs it to output the image. At this time, the user of the terminal 2 may connect to the image forming apparatus 1 with logging in or may connect as a “guest” without logging in.

Then, the person detection unit 110 of the image forming apparatus 1 activates the imaging unit 20 to image the image data 210. The person detection unit 110 transmits the captured image data 210 to the terminal 2. At this time, the driver, or the like, of the terminal 2 that has received the image data 210 displays it on the display, or the like, of the terminal 2.

With reference to FIG. 5, the user sets the range of person detection within the imaging range. The user who browses the image data 210 specifies a detection range from a GUI (Graphical User Interface) of a driver, or the like, by an angle of view, rectangular coordinates of the image data 210, or the like. The person detection unit 110 sets the designation of the detection range in the range setting 220.

In FIG. 5, in the imaging range S by the imaging unit 20, the range for detecting a person, an example is shown in which the angle of view is specified to exclude a part including the passage indicated by the diagonal line from the range for detecting a person. That is, in the passage part, someone who is not related to the person hoping to get the printed matter often goes through. Therefore, the passage part is excluded, and the detection range is set so as to recognize whether or not there is a person in the seat of general affairs staff. In this example of the range setting 220, it is shown that the hatched portion is outside the detection range of the person and is outside the target range of the person recognition. On the contrary, if there is a person in the general affairs seat, it is within the detection range and the person is detected.

In addition, once the range setting 220 is set, it is not necessary to perform this range setting process in the subsequent output of the job 200. That is, it is possible to set so that such a range setting 220 is not performed every time the printing is performed.

Further, the administrator can set the range setting 220 from the operation panel unit 16 of the image forming apparatus 1.

In addition, it is not necessary to set the range setting 220 in the first place. In this case, a person is detected in the entire imaging range S of the imaging unit 20.

(Step S101)

Next, the job acquisition unit 100 performs the job acquisition process.

After setting the range setting 220, the job 200 for printing is generated by the print instruction on the above-mentioned application of the terminal 2. In the job 200, contact setting may be added by metadata or the like. The contact setting may include the telephone number, the user's name, identification information, and an e-mail address for the terminal 2. In addition, the contact setting may include an e-mail address, a messenger address for sending and receiving text messages, a telephone number, an SMS (Short Message Service) address, and the like, for the person notifying the job 200. Further, the setting of whether to notify the transmission of the job 200 by blinking a light, a notification sound, a call by voice, an e-mail transmission, or the like, maybe similarly added to the job 200.

In addition, in the job 200, the setting of whether or not to allow the forced output even if the person to be notified is not detected (hereinafter, such an output is referred to as “forced output”) may be added as metadata, or the like. The forced output may be set automatically by the user's authority. Further, in job 200, information such as the name or the identification information for the user who permits output may be added.

The terminal 2 transmits the generated job 200 to the image forming apparatus 1.

When the job acquisition unit 100 acquires the job 200, the job acquisition unit 100 stores the job 200 in the storage unit 19.

(Step S102)
Next, the job acquisition unit 100 and the imaging unit 20 perform imaging process.

When the job 200 is acquired, the job acquisition unit 100 causes the imaging unit 20 to image the surroundings of the image forming apparatus 1.

As a result, the imaging unit 20 takes an image of the surroundings of the image forming apparatus 1 to acquire the image data 210 and stores it in the storage unit 19. The image data 210 may be still image data or movie image data.

(Step S103)

Next, the person detection unit 110 performs the person detection process.

The person detection unit 110 detects a person in the image data 210 imaged by the imaging unit 20.

Explaining with reference to FIG. 5, the person detection unit 110 first refers to the range setting 220 and sets a range for detecting a person within the imaging range of the imaging unit 20.

On this basis, the person detection unit 110 detects a person by face recognition, human body recognition, or the like within the set detection range of the image data 210, for example, by the accelerator of the CNN of the image processing unit 11. In the present embodiment, the person detection unit 110 can determine that a person is “detected”, if, for example, recognizes the person with a specific accuracy regardless of gender, face orientation, or the like. In addition, the person detection unit 110 can calculate the distance to the person by the size, or the like, in the image data 210 of the detected person. As a result, the person detection unit 110 can also detect a person who exists within a range of a specific distance.

(Step S104)

Next, the notification unit 120 determines whether or not the person is detected. If a person is detected by the person detection unit 110, the notification unit 120 determines Yes. In other cases, the notification unit 120 determines No. Specifically, for example, the notification unit 120 may determine No if a person is not detected until the time the reception of the job 200 is completed.

In the case of Yes, the notification unit 120 advances the process to step 5105.

In the case of No, the notification unit 120 advances the process to step S109.

(Step S105)

If a person is detected, the notification unit 120 performs notification process.

The notification unit 120 notifies the detected person by blinking a light, a notification sound, a call by voice, an e-mail transmission, or the like, according to a setting added to the job 200, or the like. Specifically, the notification unit 120 notifies by a blinking pattern of the LED on the display unit 61, a specific notification sound by the audio input and output unit 62, or a call by voice from the audio input and output unit 62 on the operation panel unit 16, or it notifies by sending an e-mail to the set e-mail address. This notification sound may be a ringing tone for calling according to the surrounding environment. Further, this call may be, for example, a call by voice such as “a remote job 200 has been received” by a synthetic voice. In addition to this, the name, the identification information, or the contact information of the user for the terminal 2 added to the job 200 may also be output by voice, or the like. Furthermore, the e-mail may be sent to the e-mail address of the person to notify the job 200, which is added to the job 200.

By this notification, the job 200 is waiting for output, and it is possible to request the detected person to perform processing such as acquisition of the printed matter, or the like.

Further, the notification unit 120 can attach the image data 210 when the person is detected and send it to the contact information of the user of the terminal 2 added to the job 200.

As a result, the user of the terminal 2 can confirm the image data 210 taken by the imaging unit 20 and confirm whether or not the imaged person is the person who hopes the printed matter to be processed.

(Step S106)

Next, the contact unit 130 performs contact process.

The contact unit 130 causes the person notified by the notification unit 120 to contact with the user of the terminal 2. Specifically, for example, the contact unit 130 activates the messenger application, the video call application, the telephone application, the SMS application, or the like, in the terminal 2 by using the driver, or the like, in the terminal 2. Thus, the display unit 61, the input unit 60, and the audio input and output unit 62 in the operation panel unit 16 can be used to communicate with the terminal 2 by chat, voice call, video call, or the like.

At the time of this contact, the contact unit 130 acquires the output instruction or the output cancel instruction of the job 200 by the user of the terminal 2 or the notified person.

In addition, the user of the terminal 2 may only confirm the notification, and the printed matter may be processed by the detected person without contacting the contact unit 130.

In this case, the user of the terminal 2 may be regarded to have acquired the output instruction of the job 200 by the above notification. Alternatively, the notification unit 120 may detect that the detected person has performed the output instruction for the job 200.

(Step S107)

Next, the notification unit 120 determines whether or not there is an output instruction for the job 200. The notification unit 120 determines Yes if, for example, an output instruction for the job 200 is given during the contact unit 130 is contacted. Alternatively, the notification unit 120 determines Yes even if the user of the terminal 2 or the detected person gives an instruction to output the job 200 without contacting the contact unit 130. The notification unit 120 determines No in other cases, such as if the output of the job 200 is not instructed or if the instruction to cancel the output of the job 200 is instructed.

In the case of Yes, the notification unit 120 advances the process to step S108.

In the case of No, the notification unit 120 advances the process to step S113.

(Step S108)

If there is an output instruction for job 200, the notification unit 120 and the image forming unit 17 perform output process.

The notification unit 120 causes the image forming unit 17 to execute the acquired print job 200. As a result, the document, or the like, of the job 200 is recorded on the recording paper, and the detected person processes such as acquiring the printed matter.

At this time, the contact unit 130 can take an image of the person by the imaging unit 20, transmit the image data 210, and watch until all the documents of the job 200 are output.

Further, the contact unit 130 can contact by chat, voice call, video call, or the like, even if a trouble such as printing failure occurs. This makes it possible to quickly respond to troubles.

After that, the notification unit 120 ends the remote output process.

(Step S109)

If no person is detected, the notification unit 120 and the person detection unit 110 perform a hold process.

If a person is not detected in the image data 210 within the range set in the range setting 220, the notification unit 120 puts the job 200 in the hold state of output.

At this time, the notification unit 120 waits for a specific time, for example, several seconds to several tens of minutes, until the human sensor 21 detects a person. If a person is detected, the notification unit 120 causes the imaging unit 20 to take an image and acquires the image data 210. The specific time may be set as the metadata of the job 200 or the setting value of the storage unit 19. In addition, the image capturing unit 20 may continuously image the image data 210 in real time.

On this basis, in the same manner as the person detection process similar to step 5103 as described above, the person detection unit 110 detects a person within the detection range of the range setting 220.

Here, if a person is detected within the detection range, the notification unit 120 notifies the user of the terminal 2 by e-mail, messenger, SMS, or the like, and transmits the image data 210 to the user of the terminal 2. Subsequent process may be performed in the same manner as the communication process in step S106.

On the other hand, if the person is not detected within the specific time, the notification unit 120 advances the process to step S111.

(Step S110)

If no person is detected even in the hold state, the notification unit 120 determines whether or not the forced output is permitted.

The notification unit 120 determines Yes if the metadata, or the like, in the job 200 is set to allow forced output. In other cases, the notification unit 120 determines No.

In the case of Yes, the notification unit 120 advances the process to step S111.

In the case of No, the notification unit 120 advances the process to step S113.

(Step S111)

If the forced output is permitted, the notification unit 120 and the image forming unit 17 perform the forced output process.

Although the forced output process is performed in the same manner as the output process in step S108, no post-output process is requested.

(Step S112)

Next, the notification unit 120 and the imaging unit 20 perform the reimaging process.
When the notification unit 120 detects that the printed matter of the job 200 has been taken out by the human sensor 21 or the sensor of the stack tray 50, the image data 210 is imaged by the imaging unit 20. As a result, when the printed matter is forcibly output, the person who took out the printed matter can be recorded in the storage unit 19.

The notification unit 120 may transmit the taken image data 210 to the user of the terminal 2. Otherwise, as in the contact processes described above, the person who took out the printed matter may be contacted by using the contact unit 130.

After that, the notification unit 120 ends the remote output process.

(Step S113)

If canceling the output of the job 200, the notification unit 120 performs the job cancel process.

The notification unit 120 notifies the user of the terminal 2 that the output of the job 200 has been canceled by e-mail, messenger, SMS, or the like.

Then, the data of the job 200 stored in the storage unit 19 is deleted.

As described above, the remote output process according to the embodiment of the present disclosure is completed.

As configured in this way, the following effects can be obtained.

In recent years, as the number of people working in home due to the influence of pandemics has increased, the number of cases in which documents are printed by an image forming apparatus in an office from a remote environment such as at home is increasing. In this case, there are an increasing number of cases where the output documents are processed by people in the office. The process is, for example, paperwork such as sending documents or stamping an approval stamp and then submitting it to the general affairs.

However, in a typical image forming apparatus, a user who prints remotely cannot determine the situation around the image forming apparatus. That is, it is difficult to know who is in use, who is around the apparatus, and so on. Therefore, it was not possible to know whether or not the output recording paper was surely handed over to the person who wanted the printed matter to be processed.

More specifically, when GPS or Bluetooth (Registered trademark) is used for user authentication as in a typical technology, as long as the terminal is nearby, a specified range of users may be detected and authentication is completed without the person himself or herself.

For such reason, the remote output lacked output certainty.

On the other hand, the image forming apparatus 1 according to the embodiment of the present disclosure includes a job acquisition unit 100 that acquires a job 200; an imaging unit 20 that acquires an image data 210 by imaging the surroundings when the job 200 is acquired by the job acquisition unit 100; a person detection unit 110 that detects a person in the image data 210 acquired by the imaging unit 20; a notification unit 120 that notifies the person to request a response to the job 200 when the person is detected by the person detection unit 110; and an image forming unit 17 that forms an image of the job 200 after being notified by the notification unit 120.

With this configuration, the user who performs the job 200 can confirm the image captured by the imaging unit 20. Then, the user can perform the print job 200 after confirming the person who wants the printed matter to be processed. Therefore, the job 200 can be performed by surely confirming the person from a remote place. In addition, it is possible to have a substitute person handle it flexibly.

In this way, printing can be reliably performed while the user is in a remote environment away from the image forming apparatus 1. As a result, reliable processing can be performed with the speed equivalent to handing over as in the office. In addition, as the number of people working in home increases, it becomes possible to print with high security.

Also, in a typical technique, prior user registration was required in order to use long-distance authentication. For example, face registration was required for camera face recognition, and pairing registration, or the like, was required for Bluetooth (R). As a result, new users could not perform highly secure remote printing.

On the other hand, the image forming apparatus 1 according to the present embodiment enables remote printing that does not require pre-registration. That is, even in the guest mode without pre-registration, the printed matter can be safely output by the image forming apparatus 1 from a remote location such as at home. Further, by adding the contact information, or the like, of the user of the terminal 2 to the metadata of the job 200, it is possible to acquire the notification result, or the like, even in the guest mode.

Further, the present disclosure image according to the embodiment of the image forming apparatus 1 further including a contact unit 130 that contacts the person notified by the notification unit 120.

With this configuration, even if the detected person is a person who has not been explained in advance, the instruction can be appropriately transmitted.

In addition, even higher security can be realized by chat, voice call, video call, or the like.

Further more, giving thanks and small talking while working is possible, and the user can communicate as in the office. Thus, remote office work can be made smoother by communicating with smiles, conversational requests, and gratitude that accompany the delivery of printed matter.

Further, in the image forming apparatus 1 according to the embodiment of the present disclosure, the notification by the notification unit 120 includes blinking light, a notification sound, a call by voice, and an e-mail transmission.

With this configuration, according to the office environment, it is possible to give a notification that the job 200 is desired to be processed, appropriately. As a result, remote output can be performed more reliably, and the administrative burden can be reduced.

Further, in the present disclosure an image forming apparatus 1 according to the present embodiment, the person detection unit 110 is set with a range for detecting a person within the imaging range of the imaging unit 20 as the range setting 220.

With such a configuration, it helps to surely request the processing to the person in charge such as the office worker of the general affairs who is in charge of the processing of the image forming apparatus. Furthermore, it is possible to avoid a situation in which a person who happens to pass by a passage, or the like, is notified. As a result, the printed matter of the job 200 can be processed reliably and smoothly.

Further, in the image forming apparatus 1 according to the embodiment of the present disclosure, the imaging unit 20 takes an image even when printed matter of the job 200 is taken out.

With this configuration, even if a person who can be requested processing is not detected when the job 200 is transmitted and forced output is performed, it is possible to know who acquired the printed matter. Therefore, it can contribute to smooth processing. In addition, it can enhance security at remote output and prevent it from being taken away.

### Other Embodiments

In the above-described embodiment, an example of detecting a person after acquiring the job 200 has been described.

However, the entire job 200 may not be received, but may be output after being detected a person and obtaining permission for output.

Further, in the above-described embodiment, an example in which the image forming apparatus 1 acquires and outputs the job 200 has been described.

However, the image forming system including the server 3 may execute the remote output in the same manner as in the above-described embodiment.

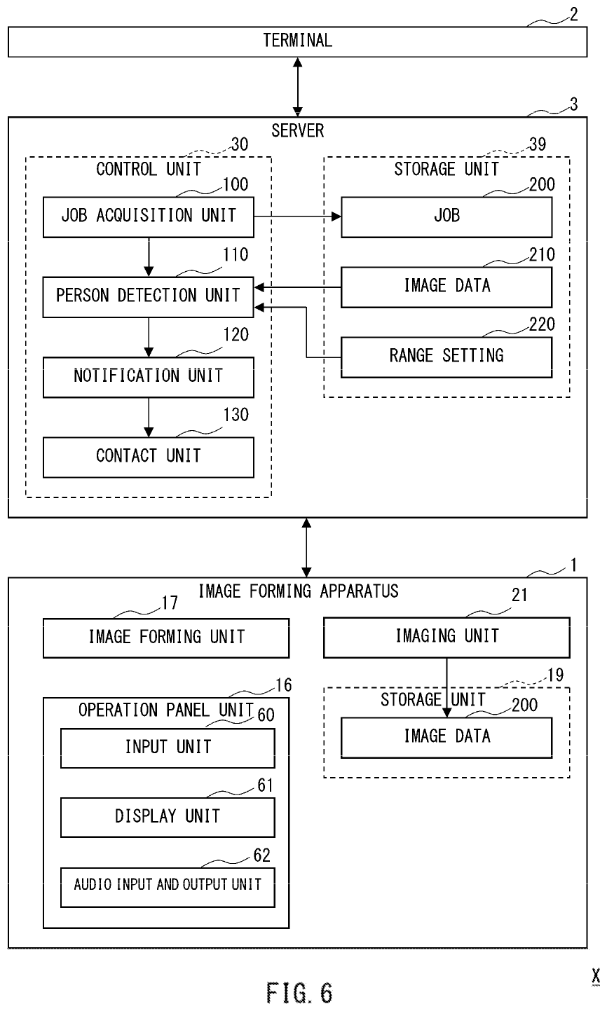

FIG. 6 shows an example of the functional configuration of such an image forming system X. In this example, the image forming apparatus 1, the terminal 2, and a server 3 are connected by a similar network 5 as in FIG. 1, and data is transmitted and received between the apparatuses. In FIG. 6, the same reference numerals as those in FIG. 3 indicate that they have similar configuration.

Specifically, in the image forming system X, the job 200 is once transmitted from the terminal 2 to the server 3, and this is pulled out by the image forming apparatus 1 and output. At this time, it is possible to perform the same process as the above-mentioned remote output process. In this example, the server 3 performs specific processing of person detection and notification.

Further, in the image forming system X, it is also possible to perform a pull print that outputs the job 200, which is once stored in the server 3, according to the instruction from the image forming apparatus 1.

At the time of the pull print, the same process as the above-mentioned remote output process may be performed. At this time, in the image forming apparatus 1, an unauthenticated person such as a guest may send a download request to the server 3. Then, in response to this request, it is possible to notify, contact, or the like, as in the case of the remote output described above. In this case, even a person other than the user of the terminal 2 can output by pull print without separately registering, or the like.

In the example of FIG. 6, although it is described that only the server 3 performs processing such as person detection, it is also possible to share the processing among the image forming apparatus 1, the terminal 2, and the server 3.

Similarly, also in the above-described embodiment, various processes including person detection, and the like, may be executed on the terminal 2.

With such a configuration, a process can be executed in an appropriate apparatus, and a flexible configuration can be supported.

Further, in the above-described embodiment, an example in which the image forming apparatus 1 does not authenticate the detected person is described.

However, this person may be authenticated, and in response to this authentication, it may be output when the job 200 is permitted to be output by the name and identification information of this authenticated user. As a result, the same process as a pull print can be performed.

Further, face authentication may be used to recognize the user's name and identification information.

In the above-described embodiment, it is described that the person is detected as soon as the job 200 is acquired.

However, it may be detected by the human sensor 21 and then imaged by the imaging unit 20.

In the above-described embodiment, an example in which a print job is performed as job 200 has been described.

However, for the job such as scan job, network scan job, job of facsimile transmission and reception, performing similar remote process is possible.

Further, the present disclosure can be applied to an information processing apparatus other than the image forming apparatus. That is, a network scanner, a server, or the like, to which the scanner is separately connected by USB, or the like, may be used.

Further, it goes without saying that the configuration and operation of the above-described embodiment are examples, and it can be appropriately modified and executed without departing from the aim of the present disclosure.

1. An image forming apparatus comprising:
a job acquisition unit configured to acquire a job from a terminal in a remote environment;
an imaging unit configured to acquire an image data by imaging the surroundings when the job is acquired by the job acquisition unit;
a person detection unit configured to detect a person in the image data acquired by the imaging unit;
a notification unit configured to notify the person to request a response to the job when the person is detected by the person detection unit; and
an image forming unit configured to form an image of the job after being notified by the notification unit; wherein
the notification unit is configured to, when the person is detected, send the image data to contact information of a user of the terminal for confirmation.

2. The image forming apparatus according to claim 1, further comprising:
a contact unit configured to contact the person notified by the notification unit with the user of the terminal.

3. The image forming apparatus according to claim 1, wherein
the notification by the notification unit includes a blinking light, a notification sound, a call by voice, or an e-mail transmission.

4. The image forming apparatus according to claim 1, wherein
the person detection unit is set with a range for detecting the person within an imaging range of the imaging unit, and
setting of the imaging range is based on exclusion by an angle of view or rectangular coordinates of the image data to be imaged.

5. The image forming apparatus according to claim 1, wherein
the imaging unit takes an image of a person who takes out a printed matter even when the printed matter of the job is taken out.

6. An image forming method performed by an image forming apparatus, comprising the steps of:
acquiring a job from a terminal in a remote environment;
acquiring an image data by imaging the surroundings when the job is acquired;
detecting a person in acquired image data;
notifying the person to request a response to the job when the person is detected;
forming an image of the job after being notified; and
when the person is detected, sending the image data to contact information of a user of the terminal for confirmation.

7. The image forming method according to claim 6, further comprising a step of:
contacting the notified person with the user of the terminal.

8. The image forming method according to claim 6, wherein
the notification includes a blinking light, a notification sound, a call by voice, or an e-mail transmission.

9. The image forming method according to claim 6, wherein
a a range is for detecting the person within an imaging range; and
setting of the imaging range is based on exclusion by an angle of view or rectangular coordinates of the image data to be imaged.

10. The image forming method according to claim 6, wherein the method comprises
imaging a person who takes out a printed matter even when the printed matter of the job is taken out.

11. An image forming system having a terminal, an image forming apparatus, and a server, comprising:
a job acquisition unit configured to acquire a job from a terminal in a remote environment;
an imaging unit configured to acquire an image data by imaging the surroundings when the job is acquired by the job acquisition unit;
a person detection unit configured to detect a person in the image data acquired by the imaging unit;
a notification unit configured to notify the person to request a response to the job when the person is detected by the person detection unit; and
an image forming unit configured to form an image of the job after being notified by the notification unit, wherein
the notification unit is configured to, when the person is detected, send the image data to contact information of a user of the terminal for confirmation.

12. The image forming system according to claim 11, further comprising:
a contact unit configured to contact the person notified by the notification unit with the user of the terminal.

13. The image forming system according to claim 11, wherein
the notification by the notification unit includes a blinking light, a notification a sound, a call by voice, or an e-mail transmission.

14. The image forming system according to claim 11, wherein
the person detection unit is set with a range for detecting the person within a imaging range of the imaging unit; and
setting of the imaging range is based on exclusion by an angle of view or rectangular coordinates of the image data to be imaged.

15. The image forming system according to claim 11, wherein
the imaging unit takes an image of a person who takes out a printed mater even when the printed matter of the job is taken out.

16. The image forming apparatus according to claim 1, wherein
the contact information is included as metadata in the job.

17. The image forming apparatus according to claim 2, wherein
the contact unit communicates with the terminal by chat, voice call, or video call.

18. The image forming apparatus according to claim 5, wherein
the job is added with a forced output setting as to whether or not to allow forced output even when the person to be notified is not detected, and
at the time of the forced output, the person who takes out the printed matter is imaged.
